(19) United States
(12) Patent Application Publication
(10) Pub. No.: US 2002/0181704 A1
(43) Pub. Date: Dec. 5, 2002

(54) Data encryption circuit pre-holding next data to be operated in buffer

(75) Inventor: Atsuo Yamaguchi, Hyogo (JP)

Correspondence Address: McDERMOTT, WILL & EMERY, 600 13th Street, N.W., Washington, DC, 20005-3096, US

(73) Assignee: Mitsubishi Denki Kabushiki Kaisha

(21) Appl. No.: 10/095,057

(22) Filed: Mar. 12, 2002

(30) Foreign Application Priority Data
Jun. 4, 2001 (JP) 2001-167780(P)

(51) Int. Cl. H04K 1/04

(52) U.S. Cl. 380/37

(57) ABSTRACT

A data encryption circuit includes a plurality of buffers; an operation unit reading block data to be processed from any one of the buffers, executing an encryption or a decryption operation process, and writing the processed result into any one of the buffers; a data control unit writing block data to be processed into any one of the buffers and reading the operation result at the operation unit from any one of the buffers; and a buffer designating unit designating a buffer to be an object of input/output for the operation unit and data control unit, so as to prevent coincidence of a buffer into which data is read by the operation unit, a buffer into which data is written by the operation unit, a buffer into which data is read by the data control unit, and a buffer into which data is written by the data control unit.

### BACKGROUND OF THE INVENTION

1. Field of the Invention

The present invention relates to a data encryption circuit, and particularly, to a data encryption circuit dividing data into blocks and performing an encryption process or a decryption process for each of the divided blocks.

2. Description of the Background Art

With recent advancement of network technology, as represented by the Internet, various information have come to flow on the network. Thus, various techniques for encryption have been proposed for the purpose of maintaining security of information.

As disclosed in Japanese Patent No. 3,088,337, an example of the encryption process is a block encryption process in which data is divided into blocks each having a predetermined size, e.g. 64 bits, and encryption is performed per block. The block encryption process includes an ECB (Electronic Code Book) mode and a CBC (Cipher Block Chaining) mode. The ECB mode is a basic mode used in a symmetric key cryptography. The CBC mode is a technique by which a different result is generated for each block in conjunction with preceding and/or succeeding blocks to make it difficult to decipher encrypted data because encrypted data may rather easily be deciphered if similar blocks are separately ciphered.

Referring to FIGS. 21A and 21B, the encryption process and decryption process in the ECB mode will be briefly described. Referring to FIG. 21A, in encryption, normal data (message) M is divided into 64-bit blocks, and a block Mn (n=1, 2, 3 . . . ) is generated. Using data K of 64 bits that is referred to as a secret “key” which is known only to a transmitter and a receiver, an ECB core performs the encryption process per block, to generate a ciphertext Cn (n=1, 2, 3 . . . ) of 64 bits (see equation (1)).

Cn=K (Mn)(n=1, 2, 3 . . . ) (1)

Referring to FIG. 21B, in decryption, a message Mn is generated from ciphertext Cn (n=1, 2, 3 . . . ), using the same key K as the one used in the encryption (see equation (2)).

Mn=K(Cn)(n=1, 2, 3 . . . ) (2)

Referring to FIGS. 22A and 22B, the encryption process and decryption process in the CBC mode will be briefly described. Referring to FIG. 22A, in encryption, an exclusive OR is obtained between the current block Mn and a ciphertext block Cn−1 of the immediately preceding block Mn−1, which is to be an input of the ECB core, and a ciphertext block Cn is obtained. This is repeated and the results are chained one after another (see equations (3) and (4)).

C1=K(M1+IV) (3)

Cn=K(Mn+(Cn−1))(n=2, 3, . . . ) (4)

wherein IV is an initial value, and is used in the first encryption and decryption. The same value is used for IV in the decryption and encryption. The value of IV may be open to the third person, and thus it is unnecessary to keep the IV secret between the transmitter and receiver. By changing the value of IV, a different ciphertext is generated from the same message.

Referring to FIG. 22B, in decryption, an output message block Mn is obtained by an exclusive OR between the decrypted result of ciphertext block Cn decrypted in a manner similar to that of the ECB mode and the immediately preceding ciphertext block Cn−1. This is repeated and the results are chained one after another (see equations (5) and (6)). In the equations (5) and (6), the sign “+” indicates exclusive OR.

M1=K(C1)+IV (5)

Mn=K(Cn)+(Cn−1)(n=2, 3, . . . ) (6)

In such an encryption process, a buffering technique may be used to enhance the processing rate.

FIG. 23 shows the flow of the encryption process with respect to time in the case where no buffering is employed. A CPU (Central Processing Unit) supplies an input to an encryption unit (ECB core) and waits until operation is completed. When the operation is completed, the CPU reads out the data for which the operation is completed and supplies the next data to the encryption unit. Such a series of processes is repeated for each block. However, using this method, the encryption unit cannot execute operation at the stage where the CPU is reading out the data for which the operation was completed or is preparing the data to be input into the encryption unit. This makes it difficult to fully actuate the encryption unit.

On the other hand, FIG. 24 shows the flow of the encryption process with respect to time in the case where the buffering technique is used. The CPU supplies input data to an encryption unit, prepares the next input data in an A state where the encryption unit has come to be in operation, and sets the next input data to an input buffer of the encryption unit. After the operation is completed, the encryption unit writes the operation result into an output buffer. The encryption unit successively takes out the input data that has been set to the input buffer, and immediately initiates the next operation. The CPU takes out the operation result from the output buffer in a B state where the completion of the operation is ascertained, and executes a necessary process. The CPU prepares the next input data and sets the data to the input buffer. By repeating these operations, encryption of a large number of data is realized in a short period of time.

Japanese Patent Laying-Open No. 11-88320 discloses a data encryption circuit in which each encryption unit is provided with an input buffer and an output buffer. Thus, the data encryption circuit can execute rapid encryption of data.

However, such a conventional data encryption circuit, in which an input buffer and an output buffer were provided for each encryption unit, increases the circuit scale. In recent years, as IC (Integrated Circuit) cards have become widespread, there has been an increased demand for a data encryption circuit having a small circuit scale and capable of rapid processing.

### SUMMARY OF THE INVENTION

The present invention was made to solve the problems described above, and an object of the present invention is to provide a data encryption circuit having a small circuit scale and capable of rapid processing.

Another object of the present invention is to provide an encryption circuit having a small circuit scale and capable of rapid processing, which can execute an encryption process and a decryption process in an ECB mode and an encryption process and a decryption process in a CBC mode.

According to an aspect of the present invention, a data encryption circuit includes a buffer unit including a plurality of buffers; an operation unit connected to the buffer unit and capable of transferring data to/reading data from any of the buffers included in the buffer unit, reading block data to be processed from any one of the buffers included in the buffer unit, executing one of an encryption operation process and a decryption operation process, and writing a process result into any one of the buffers; a data control unit connected to the buffer unit, writing block data to be processed into any one of the buffers included in the buffer unit, and reading an operation result at the operation unit from any one of the buffers; and a buffer designating unit connected to the buffer unit, the operation unit and the data control unit, designating buffers to be an object of input/output with respect to the operation unit and the data control unit, so as to prevent coincidence of a buffer into which data is read by the operation unit, a buffer into which data is written by the operation unit, a buffer into which data is read by the data control unit, and a buffer into which data is written by the data control unit.

The operation unit can transfer data to/read data from any buffer included in the buffer unit. Thus, it is possible to use one buffer to be served both as a buffer for input data and as a buffer for output data. Moreover, a plurality of buffers are provided. Thus, it is possible to pre-provide input data to be operated next, even if the operation unit is in the middle of operation, so that the process performance of the data encryption circuit is enhanced. Furthermore, the number of buffers can be reduced, and therefore the data encryption circuit having a small circuit scale and capable of rapid processing can be realized.

Preferably, the buffer designating unit includes a plurality of state registers respectively holding states taken by the plurality of buffers included in the buffer unit, and a decoder connected to the plurality of state registers, and supplying signals corresponding to values of the plurality of state registers to the plurality of buffers constituting the buffer unit, to the operation unit and to the data control unit, and the operation unit and the data control unit operate based on the signals supplied from the decoder.

More preferably, each of the plurality of state registers stores, in a corresponding buffer, data indicating any one of a state where pre-operation data can be written, a state where pre-operation data is stored, a state where an operation result is stored, and a state where stored data is being operated.

More preferably, the decoder supplies, to each of the plurality of buffers, a first signal indicating whether the data control unit can write block data, a second signal indicating whether the data control unit can read an operation result, a third signal indicating whether the operation unit can take out input data waiting for operation, and a fourth signal indicating whether the operation unit can write an operation result.

More preferably, the decoder supplies the third and fourth signals such that an operation result is written into a same buffer as a buffer from which block data is taken out by the operation unit.

Such control of the signals allows execution of the encryption process and decryption process in the ECB mode.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing the configuration of a data encryption circuit according to the first embodiment;

FIG. 2 is a block diagram showing the configuration of an operation unit according to the first embodiment;

FIG. 3 is a time chart for the operation unit according to the first embodiment;

FIG. 4 shows a table indicating relations between buffers and various signals output from a decoder;

FIGS. 5 and 6 show a flow chart of an encryption process performed by the data encryption circuit;

FIG. 7 is a block diagram showing the configuration of a data encryption circuit according to the second embodiment;

FIG. 8 is a block diagram showing the configuration of an operation unit according to the second embodiment;

FIG. 9 is a time chart for encryption in the CBC mode performed by the operation unit according to the second embodiment;

FIG. 10 is a time chart for decryption in the CBC mode performed by the operation unit according to the second embodiment;

FIG. 11 shows a table indicating relations between buffers and various signals output from a decoder;

FIGS. 12 to 14 show a flow chart of an encryption process or a decryption process in the ECB mode;

FIGS. 15 to 20 show a flow chart of an encryption process in the CBC mode;

FIGS. 21A and 21B show the outline of the encryption process and decryption process in the ECB mode;

FIGS. 22A and 22B show the outline of the encryption process and decryption process in the CBC mode;

FIG. 23 is a time chart for an encryption process without buffering; and

FIG. 24 is a time chart for an encryption process with buffering.

### DESCRIPTION OF THE PREFERRED EMBODIMENTS

First Embodiment

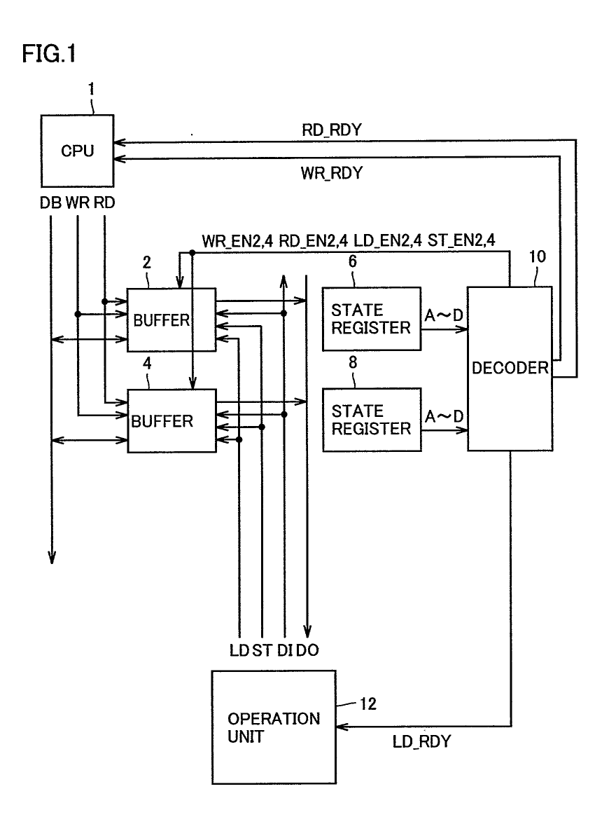

Referring to FIG. 1, a data encryption circuit according to the first embodiment of the present invention includes an operation unit 12 executing an encryption process and a decryption process; buffers 2 and 4 each connected to operation unit 12, holding block data to be input into operation unit 12 and holding a result of operation at operation unit 12; state registers 6 and 8 holding the states of buffers 2 and 4 respectively; a CPU 1 connected to buffers 2 and 4, writing block data to be encrypted into buffers 2 and 4, and reading the operation result at operation unit 12 held in buffers 2 and 4; and a decoder 10 connected to state registers 6 and 8, buffers 2 and 4, operation unit 12, and CPU 1, for supplying various signals to buffers 2 and 4, operation unit 12, and CPU 1, in accordance with the states of state registers 6 and 8.

Buffer 2 is connected to CPU 1 by a data bus DB, a write signal WR and a read signal RD. When write signal WR is activated, data can be written from CPU 1 into buffer 2. When read signal RD is activated, data can be read from buffer 2 by CPU 1. Buffer 4 operates in a manner similar to that of buffer 2. Thus, the detailed description thereof will not be repeated here.

Buffer 2 is connected to operation unit 12 by a load signal LD, a store signal ST, a data input signal DI and a data output signal DO. When load signal LD is activated, data can be read from buffer 2. Thus, operation unit 12 reads out block data from buffer 2 via data output signal DO. When store signal ST is activated, data can be written into buffer 2. Thus, operation unit 12 writes the operation result into buffer 2 via data input signal DI. Buffer 4 operates in a manner similar to that of buffer 2. Thus, the detailed description thereof will not be repeated here.

Each of buffers 2 and 4 can take four states from A to D as described below. The states are stored in each of state registers 6 and 8. State A indicates that no data is stored in a buffer. State B indicates that block data has been written from CPU 1 into a buffer and there is data waiting for operation. State C indicates that block data has been input into operation unit 12 and is being operated. State D indicates that the operation result at operation unit 12 is held in a buffer.

Each buffer shifts its state in the order of state A, state B, state C and state D, and when it reaches state D, it returns to state A.

Decoder 10 supplies the signals described below to buffers 2 and 4, to operation unit 12, and to CPU 1, in accordance with values of buffers 2 and 4, which are held in state registers 6 and 8 respectively. Buffer 2 is supplied with a signal WR_EN2 indicating whether or not data can be written from CPU 1, a signal RD_EN2 indicating whether or not data can be read out by CPU 1, a signal LD_EN2 indicating whether or not data can be read out by operation unit 12, and a signal ST_EN2 indicating whether or not the operation result can be written by operation unit 12. Buffer 4 is also supplied with similar signals WR_EN4, RD_EN4, LD_EN4 and ST_EN4.

Moreover, decoder 10 transmits a signal WR_RDY indicating that data can be written into either one of buffers 2 and 4, and a signal RD_RDY indicating that data can be read out from either one of the buffers. The value indicated by signal WR_RDY is a logical OR of signals WR_EN2 and WR_EN4. The value indicated by signal RD_RDY is a logical OR of signals RD_EN2 and RD_EN4.

Further, decoder 10 supplies a signal LD_RDY to operation unit 12, indicating presence or absence of data to be operated. The value of signal LD_RDY is a logical OR of signals LD_EN2 and LD_EN4. In response to signal LD_RDY, operation unit 12 executes an encryption process.

Signal WR supplied from CPU 1 is accepted by a buffer determined in accordance with signal WR_EN2 or WR_EN4 output from decoder 10. Decoder 10 performs control so as to prevent signals WR_EN2 and WR_EN4 from being simultaneously supplied to buffers 2 and 4. Similarly, signal RD is also accepted by a buffer determined in accordance with signal RD_EN2 or RD_EN4 output from decoder 10. Decoder 10 performs control so as to prevent signals RD_EN2 and RD_EN4 from being simultaneously supplied to buffers 2 and 4. Thus, a signal from decoder 10 automatically determines whether or not the signal output from CPU 1 is accepted, rather than CPU 1 selecting a buffer.

Signal LD supplied from operation unit 12 is accepted by a buffer determined in accordance with signal LD_EN2 or LD_EN4 output from decoder 10. Decoder 10 performs control so as to prevent signals LD_EN2 and LD_EN4 from being simultaneously supplied to buffers 2 and 4. Similarly, signal ST is accepted by a buffer determined in accordance with signal ST_EN2 or ST_EN4 output from decoder 10. Decoder 10 performs control so as to prevent signals ST_EN2 and ST_EN4 from being simultaneously supplied to buffers 2 and 4. Thus, a signal from decoder 10 automatically determines whether or not the signal output from operation unit 12 is accepted, rather than operation unit 12 selecting a buffer.

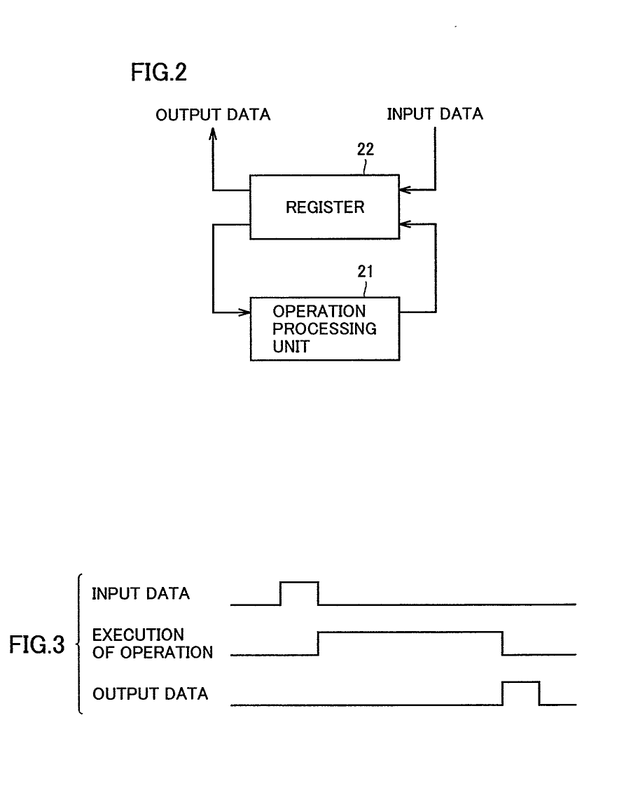

Referring to FIG. 2, operation unit 12 is a processing device executing the encryption process and decryption process in the ECB mode, and includes an operation processing unit 21 executing operation for encryption or decryption in the ECB mode, and a register 22 connected to operation processing unit 21 and to buffers 2 and 4, and holding input data read from buffer 2 or 4, or the result of operation processed at operation processing unit 21.

Referring to FIG. 3, operation unit 12 executes operation when input data is input, and thereafter, outputs data.

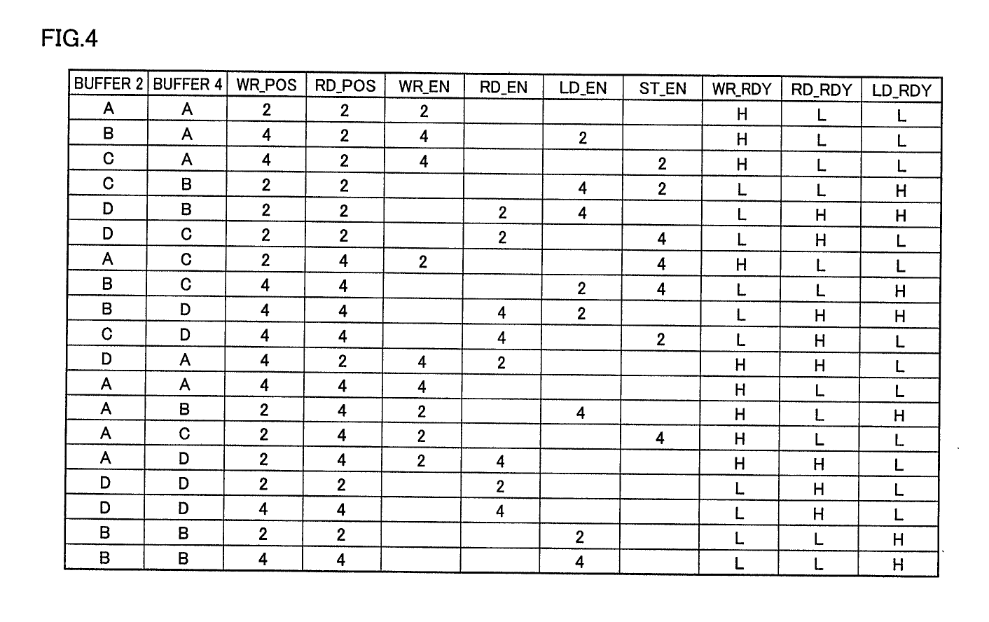

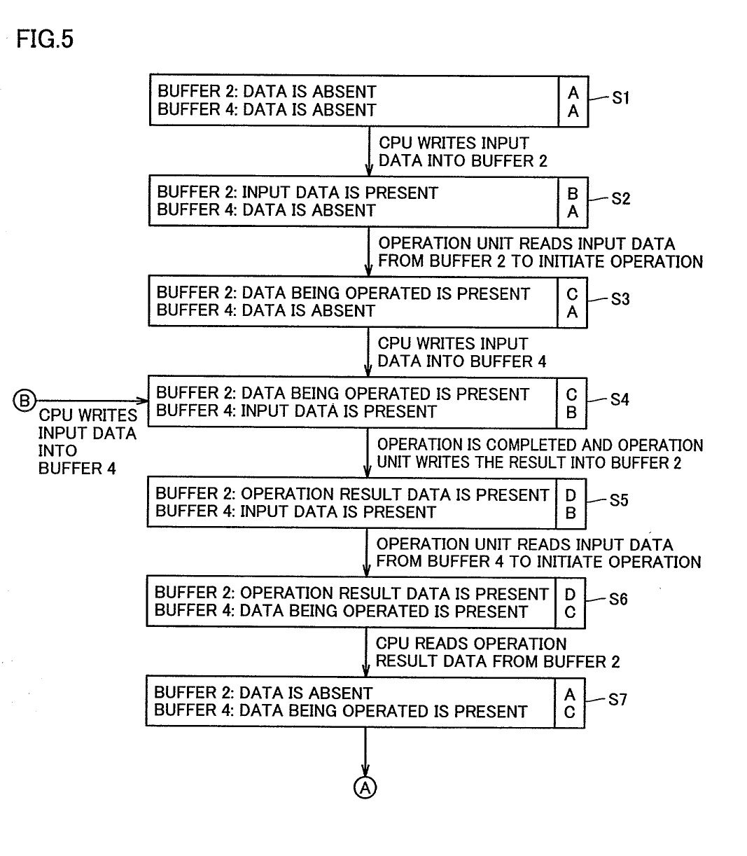

Referring to FIG. 4, the relations between buffers 2, 4 and signals WR_EN2, WR_EN4, RD_EN2, RD_EN4, LD_EN2. LD_EN4, ST_EN2, ST_EN4, WR_RDY, RD_RDY and LD_RDY.

In the table, WR_POS indicates the reference number of a buffer to which data is written when CPU 1 is allowed to write data next, and the values “2” and “4” of WR_POS indicate that CPU 1 writes data into buffers 2 and 4 respectively. WR_POS changes every time data is written from CPU 1 into buffer 2 or 4, alternately taking the values of “2” and “4.”

RD_POS indicates the reference number of a buffer from which data is read out when CPU 1 is allowed to read data next, and the value “2” and “4” of RD_POS indicate that CPU 1 reads data from buffers 2 and 4 respectively. RD_POS changes every time CPU 1 reads data from buffer 2 or 4, alternately taking the values of “2” and “4.”

The numeral in the column of WR_EN is the same as the value of WR_POS, in which “2” indicates that data can be written from CPU 1 into buffer 2, whereas “4” in the column of WR_EN indicates that data can be written from CPU 1 into buffer 4. The value indicated for WR_EN is also the value of WR_POS in the case where the buffer specified by the value of WR_POS is in state A.

The numeral in the column of RD_EN is the same as the value of RD_POS, in which “2” indicates that data can be read from buffer 2 to CPU 1, whereas “4” in the column of RD_EN indicates that data can be read from buffer 4 to CPU 1. The value indicated for RD_EN is also the value of RD_POS in the case where the buffer specified by the value of RD_POS is in state D.

When the numeral in the column of LD_EN is “2,” it indicates that data can be read from buffer 2 by operation unit 12, whereas “4” in the column of LD_EN indicates that data can be read from buffer 4 by operation unit 12. The value of LD_EN indicates the reference number of a buffer of interest in the case where the buffer is in state B. It is noted that, if all buffers are in state B, the value of LD_EN indicates the value of RD_POS (or WR_POS). Moreover, if data is read out from a buffer in state B to operation unit 12, the state of that buffer is shifted from B to C.

When the numeral in the column of ST_EN is “2,” it indicates that the operation result of operation unit 12 can be written into buffer 2, whereas “4” in the column of ST_EN indicates that the operation result of operation unit 12 can be written into buffer 4. The value of ST_EN indicates the reference number of a buffer of interest in the case where the buffer is in state C. Moreover, when data is written from operation unit 12 into the buffer in state C, the state of the buffer is shifted from C to D.

The value of WR_RDY is set to be at “H” when either one of the buffers is in state A, and is set to be at “L” otherwise. When “H” is indicated in the column of WR_RDY, it means that CPU 1 can write data into either buffer 2 or 4. When “L” is indicated in the column of WR_RDY, it means that data can be written into neither buffer 2 nor 4. Note that, when CPU 1 writes data into either buffer, the state of the buffer is shifted from A to B.

A value of RD_RDY is set to be at “H” when either one of the buffers is in state D, and is set to be at “L” otherwise. When “H” is indicated in the column of RD_RDY, it means that CPU 1 can read out data from either one of buffers 2 and 4, whereas “L” in the column of RD_RDY indicates that data can be read out from neither one of buffers 2 and 4. It is noted that, when CPU 1 reads data from either one of the buffers, the state of the buffer is shifted from D to A.

The value of LD_RDY is set to be at “H” when either one of the buffers is in state B, i.e., when the value of LD_EN is “2” or “4,” and is set to be at “L” otherwise. When “H” is indicated in the column of LD_RDY, it means that there is data to be operated by operation unit 12, whereas “L” in the column of LD_RDY indicates that there is no data to be operated by operation unit 12.

Blanks in the table shown in FIG. 4 means that neither buffer is instructed to perform the process represented by each signal.

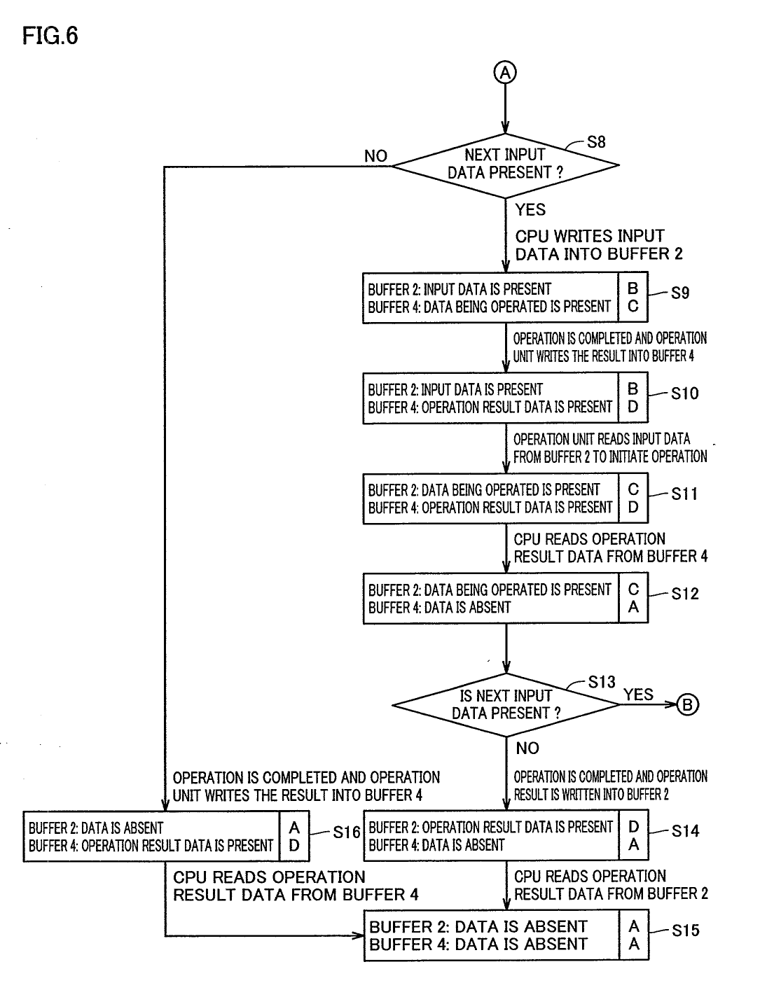

Referring to FIGS. 5 and 6, the process of encryption in the data encryption circuit operating as above will be described. It is noted that characters “A” to “D” written at the right end of each block indicate the states of buffers 2 and 4. In the initial state, both buffers 2 and 4 indicate a state where data is absent (S1). When CPU 1 writes data to be encrypted into buffer 2, the state of buffer 2 is changed to a state where input data is present in buffer 2 (S2). Operation unit 12 reads the input data from buffer 2, and operation is initiated (S3). During the operation, CPU 1 writes input data into buffer 4 (S4). When the operation is completed, operation unit 12 writes the result into buffer 2 (S5).

Operation unit 12 immediately reads the input data from buffer 4, and initiates operation (S6). While operation unit 12 is performing the operation, CPU 1 reads the operation result from buffer 2 (S7). Referring to FIG. 6, CPU 1 determines whether or not there is an input to be operated next (S8). If there is no data to be operated next (NO at S8), operation unit 12 writes the result into buffer 4 at the time point where the operation is completed (S16). CPU 1 reads data from buffer 4, and the process is terminated (S15).

If there is data to be operated next (YES at S8), CPU 1 writes input data into buffer 2 during the operation (S9). When the operation is completed, operation unit 12 writes the result into buffer 4 (S10). Operation unit 12 reads the input data from buffer 2, and initiates operation (S11). While operation unit 12 is performing the operation, CPU 1 reads the operation result (S12).

CPU 1 determines whether or not there is an input to be operated next (S13). If there is no data to be operated next (NO at S13), operation unit 12 writes the result into buffer 2 at the time point where the operation is completed (S14). CPU 1 reads data from buffer 2, and the process is terminated (S15). If there is data to be operated next, CPU writes the input data into buffer 4 (S4 in FIG. 5). Thereafter, the process from S5 downward is repeated.

As described above, according to the present embodiment, a ring buffer constituted by two buffers is used to serve both as the buffer for input data and as the buffer for output data, as shown in FIG. 1. Therefore, even though the operation unit is in the middle of operation, input data to be operated next can be pre-provided, so that the process performance of the data encryption circuit is enhanced. Moreover, the number of buffers can be reduced, and therefore the data encryption circuit capable of rapid processing can be realized.

It is noted that, while the operation unit has constant processing time, a processing time of CPU 1, including reading and writing to buffer, is varied generally depending on what is being executed. Hence, the ring buffer may be constituted by buffers of even larger number of stages, to allow rapid execution of the encryption and decryption processes.

Second Embodiment

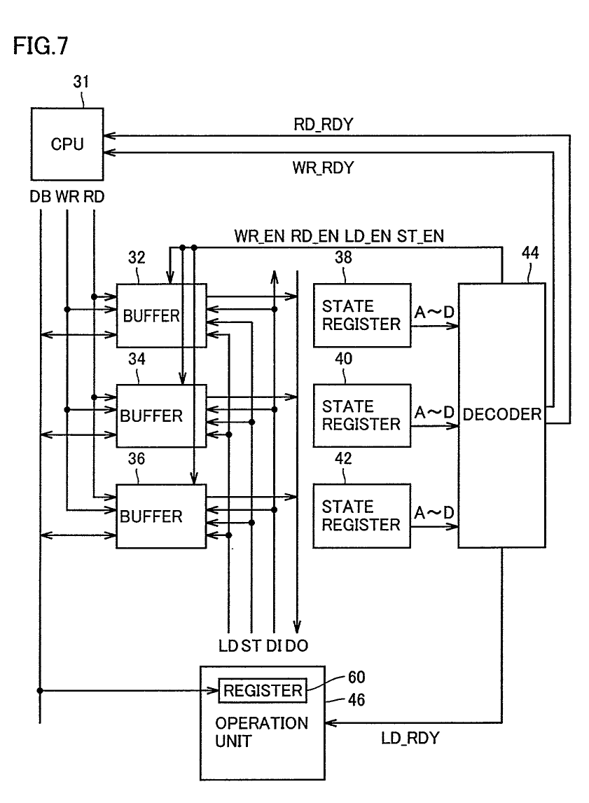

Referring to FIG. 7, a data encryption circuit according to the second embodiment of the present invention includes an operation unit 46 for executing an encryption process or a decryption process; buffers 32, 34 and 36 each connected to operation unit 46, to hold block data to be input into operation unit 46 and to hold an operation result at operation unit 46; state registers 38, 40 and 42 respectively holding the states of buffers 32, 34 and 36; a CPU 31 connected to buffers 32, 34, 36 and operation unit 46, to write block data to be encrypted into buffers 32, 34 and 36, to write an initial value into a register 60, which will be described later, provided within operation unit 46, and to read the operation results at operation unit 46 that are held in buffers 32, 34 and 36; and a decoder 44 connected to state registers 38, 40 and 42, buffers 32, 34 and 36, operation unit 46, and CPU 31, to supply various signals to buffers 32, 34 and 36, to operation unit 46 and to CPU 31, in accordance with the states of state registers 38, 40 and 42.

Each of buffers 32, 34 and 36 is connected to CPU 31 by a data bus DB, a write signal WR and a read signal RD. The states that can be taken by buffers 32, 34 and 36 depending on the values of these signals are similar to those for buffers 2 and 4 described in the first embodiment. Thus, the detailed description thereof will not be repeated here.

Furthermore, each of buffers 32, 34 and 36 is connected to operation unit 46 by a load signal LD, a store signal ST, a data input signal DI and a data output signal DO. The states that can be taken by buffers 32, 34 and 36 depending on the values of these signals are similar to those for buffers 2 and 4 described in the first embodiment. Thus, the detailed description thereof will not be repeated here.

Buffers 32, 34 and 36 can take four states from state A to state D. State A and state D are similar to those described in the first embodiment. Therefore, the detailed description thereof will not be repeated here.

Decoder 44 supplies the signals as described below to buffers 32, 34 and 36, to operation unit 46, and to CPU 31, in accordance with the values of buffers 32, 34 and 36 held in state registers 38, 40 and 42 respectively. Buffer 32 is supplied with a signal WR_EN32 indicating whether or not data can be written from CPU 31, a signal RD_EN32 indicating whether or not data can be read out by CPU 31, a signal LD_EN32 indicating whether or not data can be read out by operation unit 46, and a signal ST_EN32 indicating whether or not the operation result can be written by operation unit 46. Similarly, buffer 34 is supplied with signals WR_EN34, RD_EN34, LD_EN34 and ST_EN34. Likewise, buffer 36 is supplied with signals WR_EN36, RD_EN36, LD_EN36 and ST_EN36.

Moreover, decoder 44 transmits to CPU 31 a signal WR_RDY indicating that data can be written into any one of buffers 32, 34 and 36, and a signal RD_RDY indicating that data can be read out from any one of the buffers. The value indicated by signal WR_RDY is a logical OR of signals WR_EN32, WR_EN34 and WR_EN36. The value indicated by signal RD_RDY is a logical OR of RD_EN32, RD_EN34 and RD_EN36.

Furthermore, decoder 44 supplies, to operation unit 46, a signal LD_RDY indicating presence or absence of data to be operated. The value of signal LD_RDY is a logical OR of signals LD_EN32, LD_EN34 and LD_EN36. In response to signal LD_RDY, operation unit 46 executes an encryption process.

Signal WR supplied from CPU 31 is accepted by a buffer determined in accordance with signal WR_EN32, WR_EN34 or WR_EN36 output from decoder 44. Decoder 44 performs control so as to prevent simultaneous supply of any two or more of signals WR_EN32, WR_EN34 and WR_EN36. Likewise, signal RD is accepted by a buffer determined in accordance with signal RD_EN32, RD_EN34 or RD_EN36 output from decoder 44. Decoder 44 performs control so as to prevent simultaneous supply of any two or more of signals RD_EN32, RD_EN34 and RD_EN36. Thus, a signal from decoder 44 automatically determines whether or not the signal output from CPU 31 is accepted, rather than CPU 31 selecting a buffer.

Signal LD supplied from operation unit 46 is accepted by a buffer determined in accordance with signal LD_EN32, LD_EN34 or LD_EN36 output from decoder 44. Decoder 44 performs control so as to prevent simultaneous supply of any two or more of signals LD_EN32, LD_EN34 and LD_EN36. Likewise, signal ST is accepted by a buffer determined in accordance with signal ST_EN32, ST_EN34 or ST_EN36 output from decoder 44. Decoder 10 performs control so as to prevent simultaneous supply of any two or more of signals ST_EN32, ST_EN34 and ST_EN36. Thus, a signal from decoder 44 automatically determines whether or not the signal output from operation unit 46 is accepted, rather than operation unit 46 selecting a buffer.

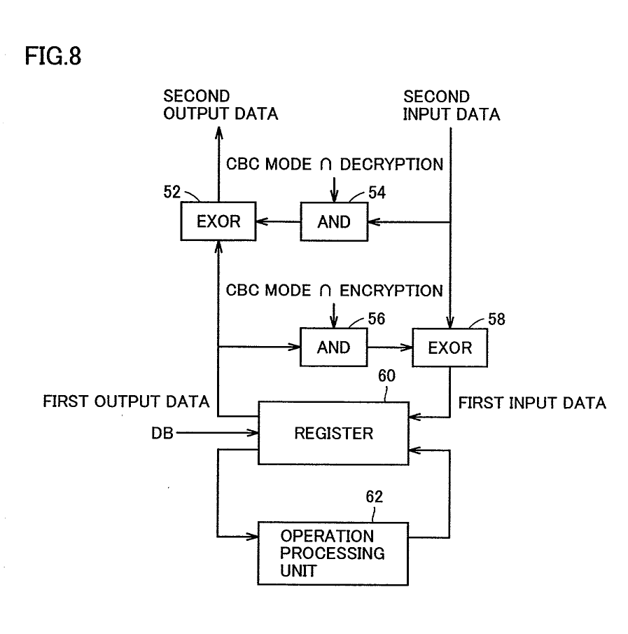

Referring to FIG. 8, operation unit 46 includes an operation processing unit 62 executing operation for encryption or decryption in the ECB mode and operation for encryption or decryption in the CBC mode; a register 60 connected to operation processing unit 62 and holding input data to be input into operation processing unit 62 and an execution result of operation processing unit 62; an AND circuit 56 executing AND operation between the value held in register 62 and a signal to be 1 in the CBC mode and also in the encryption process; an EXOR (exclusive-OR) circuit 58 connected to AND circuit 56 and register 60, to obtain an exclusive OR of the output of AND circuit 56 and input data and to write the result into register 60; an AND circuit 54 executing AND operation between the input data and a signal to be 1 in the CBC mode and also in the decryption process; and an EXOR circuit 52 connected to register 60 and AND circuit 54, to output an exclusive OR between the value held in register 60 and the output of AND circuit 54. As described above, an initial value may be directly written into register 60 from CPU 31.

In the ECB mode, the outputs of AND circuit 54 and AND circuit 56 will be zero. Thus, EXOR circuit 58 writes input data into register 60, and EXOR circuit 52 outputs output data held in register 60.

In the case of the encryption process in the CBC mode, AND circuit 56 outputs encrypted data in the immediately preceding block held in register 60. EXOR circuit 58 obtains an exclusive OR of the input data in the block of current interest and the encrypted data in the preceding block, and the result thereof is held in register 60. Operation processing unit 62 encrypts the value held in register 60, and writes the encrypted result into register 60. The data written in register 60 is supplied to EXOR circuit 58 as data used for encryption of the next block, and also is output via EXOR circuit 52.

In the case of the decryption process in the CBC mode, input data is temporarily held in register 60, is decrypted at operation processing unit 62, and thereafter the operation result is held in register 60. EXOR circuit 52 obtains an exclusive OR of the operation result held in register 60 and the immediately preceding input data (read from a buffer as the second data), and outputs the result thereof.

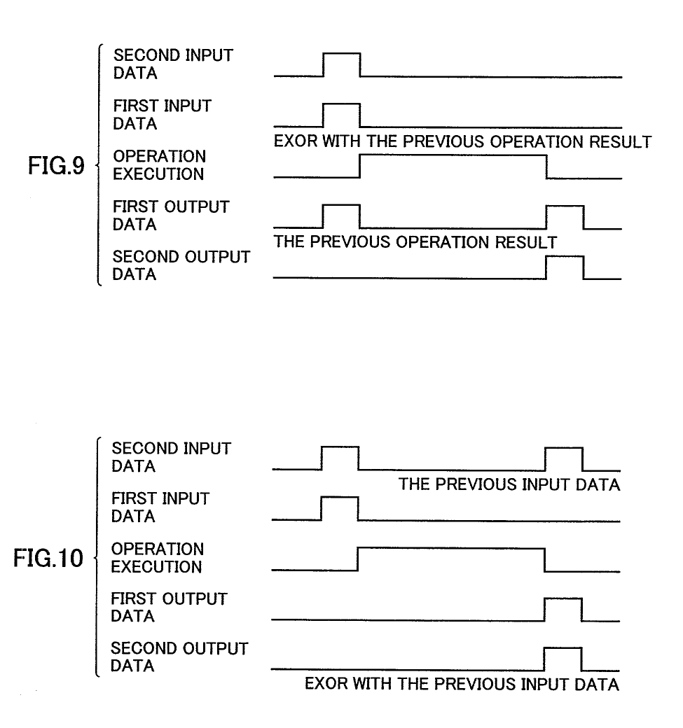

FIG. 9 shows a time chart for the encryption process in the CBC mode. An exclusive OR is calculated between the second input data and the first output data which is the previous operation result, to generate the first input data. Subsequently, encryption operation is executed for the first input data at operation processing unit 62, and the operation result is held in register 60. After the operation process, the operation result is output as the first output data and second output data.

FIG. 10 shows a time chart for the decryption process in the CBC mode. Block data to be decrypted is written into register 60 as the first input data and the second input data. At operation processing unit 62, decryption operation is executed for the block held in register 60, and the operation result is held in register 60. An exclusive OR operation is executed between the second input data which is the previous input data and the first output data which is the operation result, to output the operation result as the second output data.

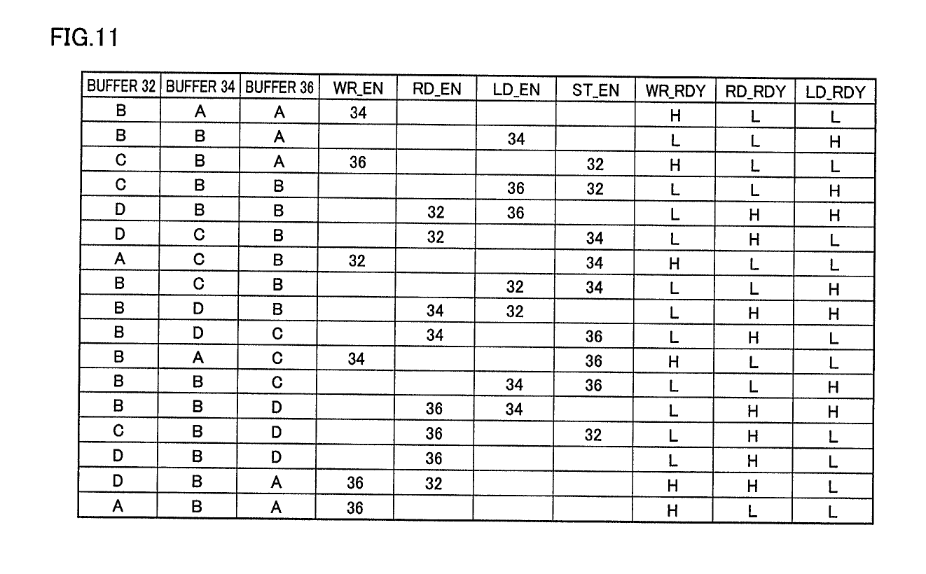

Referring to FIG. 11, the relations between buffers 32, 34 and 36, and signals WR_EN32, WR_EN34, WR_EN36, RD_EN32, RD_EN34, RD_EN36, LD_EN32, LD_EN34, LD_EN36, ST_EN32, ST_EN34, ST_EN36, WR_RDY, RD_RDY, and LD_RDY.

In the table, the numbers “32,” “34” and “36” in the column of WR_EN indicate that data can be written from CPU 31 to buffers 32, 34 and 36, respectively. The value shown in the column of WR_EN indicates the reference number of a buffer of interest in the case where the buffer is in state A whereas the buffer immediately preceding to the buffer of interest is in a state other than A. This is except for the case where the buffer of interest is in state A and all the other buffers are in state B. The buffer immediately preceding to buffer 36 indicates buffer 34. The buffer immediately preceding to buffer 34 indicates buffer 32. The buffer immediately preceding to buffer 32 indicates buffer 36. It is noted that, when CPU 31 writes data into a buffer, the state of that buffer is shifted from A to B.

The numbers “32,” “34” and “36” in the column of RD_EN indicate that data can be read to CPU 31 from buffers 32, 34 and 36, respectively. The value in the column of RD_EN indicates the reference number of a buffer of interest in the case where the buffer of interest is in state D and the buffer immediately preceding to the buffer of interest is in a state other than D. It is noted that, when CPU 31 reads out data from a buffer, the state of the buffer is shifted from D to A.

The numbers “32,” “34” and “36” in the column of LD_EN indicate that operation unit 46 can read out data from buffers 32, 34 and 36, respectively. The value in the column of LD_EN indicates the reference number of a buffer of interest in the case where the buffer of interest and the buffer immediately preceding the buffer of interest are in state B, and the buffer further preceding the immediately-preceding buffer is in a state other than B. It is noted that, when data is read out to operation unit 46, the state of the immediately-preceding buffer is shifted from B to C.

The numbers “32,” “34” and “36” in the column of ST_EN indicate that the operation result can be written by operation unit 46 into buffers 32, 34 and 36, respectively. The value of ST_EN indicates the reference number of a buffer that is in state C. It is noted that, when data is written from operation unit 46 to a buffer in state C, the state of the buffer is shifted from C to D.

The value of WR_RDY is set to be at “H” when a value is set to WR_EN, and is set to be at “L” otherwise. When “H” is indicated in the column of WR_RDY, it means that CPU 31 can write data into any one of buffers 32, 34 and 36. When “L” is indicated in the column of WR_RDY, it means that data cannot be written into any of buffers 32, 34 and 36.

The value of RD_RDY is set to be at “H” when any one of the buffers is in state D, i.e., when a value is set to RD_EN, and is set to be at “L” otherwise. When “H” is indicated in the column of RD_RDY, it means that CPU 31 can read data from any one of buffers 32, 34 and 36, whereas “L” in the column of RD_RDY indicates that data cannot be read from any of buffers 32, 34 and 36.

The value of LD_RDY is set to be at “H” when any of the buffers is in state B, i.e., when a value is set to LD_EN, and is set to be at “L” otherwise. When “H” is indicated in the column of LD_RDY, it means the presence of data to be operated by operation unit 46, whereas “L” in the column of LD_RDY indicates the absence of data to be operated by operation unit 46.

Blanks in the table shown in FIG. 11 mean that no buffer is instructed to perform the process represented by each signal.

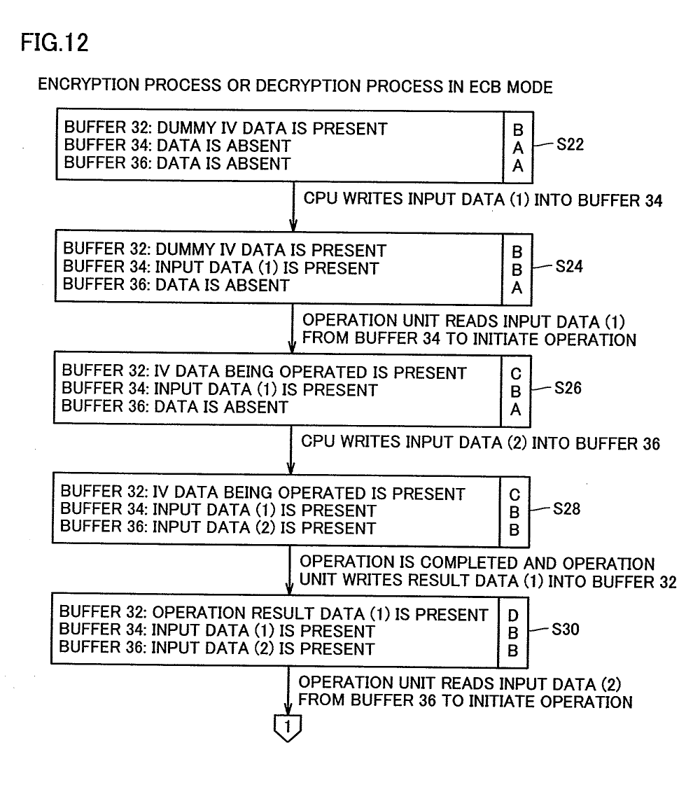

Subsequently, referring to FIGS. 12 to 20, the states of buffers 32, 34 and 36 in the case where the encryption process and decryption process are executed in the data encryption circuit operating as above will be described. It is noted that characters “A” to “D” at the right end of each block indicate the states of buffers 32, 34 and 36.

The CBC decryption requires IV data stored in a buffer, and CBC encryption requires IV data stored in register 60, not in a buffer, while ECB requires neither of the above.

However, the initial data may always be written into buffer 32 and register 60 irrespective of necessity of IV data, in order to make the processes common to one another, and buffer 32 may be set to be in state B as a result thereof.

In such a case, the initial data in ECB will be dummy IV data which will not be used. It is understood that the method of setting initial data is not limited thereto, and other methods may be employed.

Referring to FIGS. 12 to 14, the encryption process or decryption process in the ECB mode performed in data encryption circuit will be described. Though the case where four block data are input in the order of input data (1) to (4) will be described in the description below, it is understood that the number of the input data is not limited to four, and may be a larger or smaller number.

Referring to FIG. 12, when CPU 31 writes the dummy IV data into buffer 32, buffer 32 will be in a state where input data is present (S22). In this state, no input data is held in buffers 34 and 36. When CPU 31 writes data to be processed next into buffer 34, buffer 34 will have a state where input data is present (S24). Operation unit 46 reads the input data from buffer 34, to initiate operation (S26). Next, CPU 31 writes the input data into buffer 36 (S28). When the operation is completed, operation unit 46 writes the operation result into buffer 32 (S30).

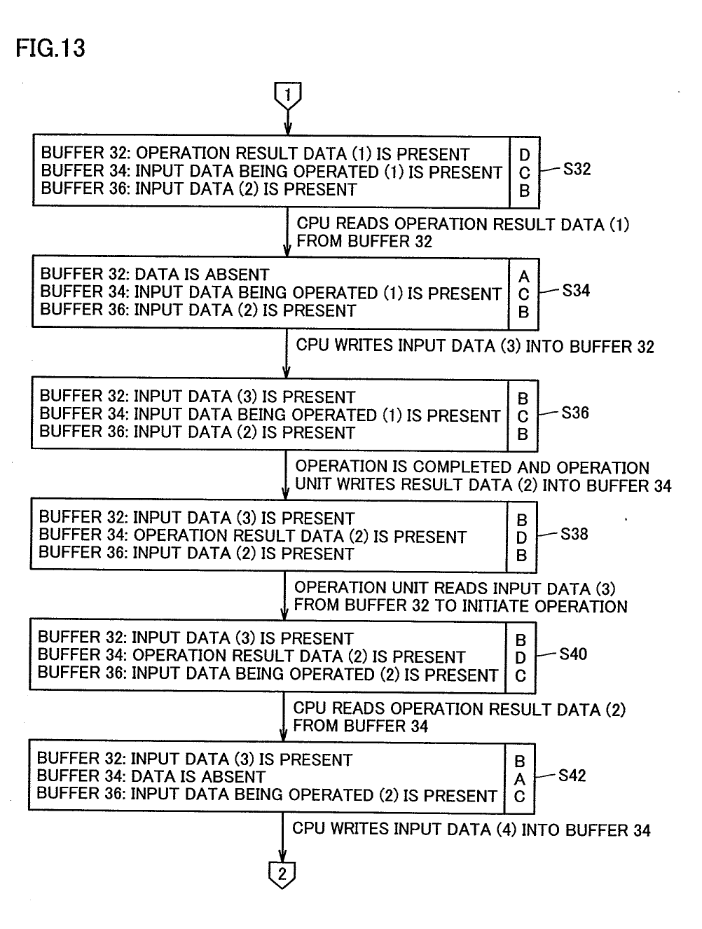

Referring to FIG. 13, operation unit 46 reads input data from buffer 36 to initiate operation (S32). During the operation, CPU 31 reads the data of the operation result from buffer 32 (S34). CPU 31 writes the input data into buffer 32 (S36). When the operation is completed, operation unit 46 writes the result data into buffer 34 (S38). Operation unit 46 reads input data from buffer 32, to initiate operation (S40). CPU 31 reads the data of the operation result from buffer 34 (S42).

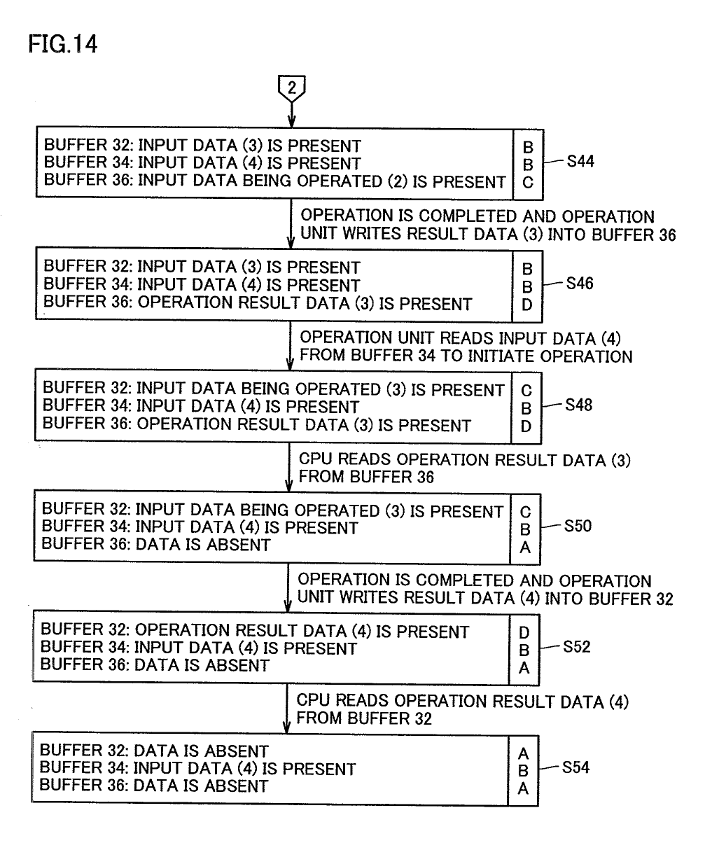

Referring to FIG. 14, CPU 31 writes the input data into buffer 34 (S44). The operation is completed, and operation unit 46 writes the result data into buffer 36 (S46). Operation unit 46 reads the input data from buffer 34 and initiates operation (S48). CPU 31 reads the data of the operation result from buffer 36 (S50). When the operation is completed, operation unit 46 writes the result data into buffer 32 (S52). CPU 31 reads the data of the operation result from buffer 32 (S54). By repeating the process described above, the encryption process and decryption process in the ECB mode are realized.

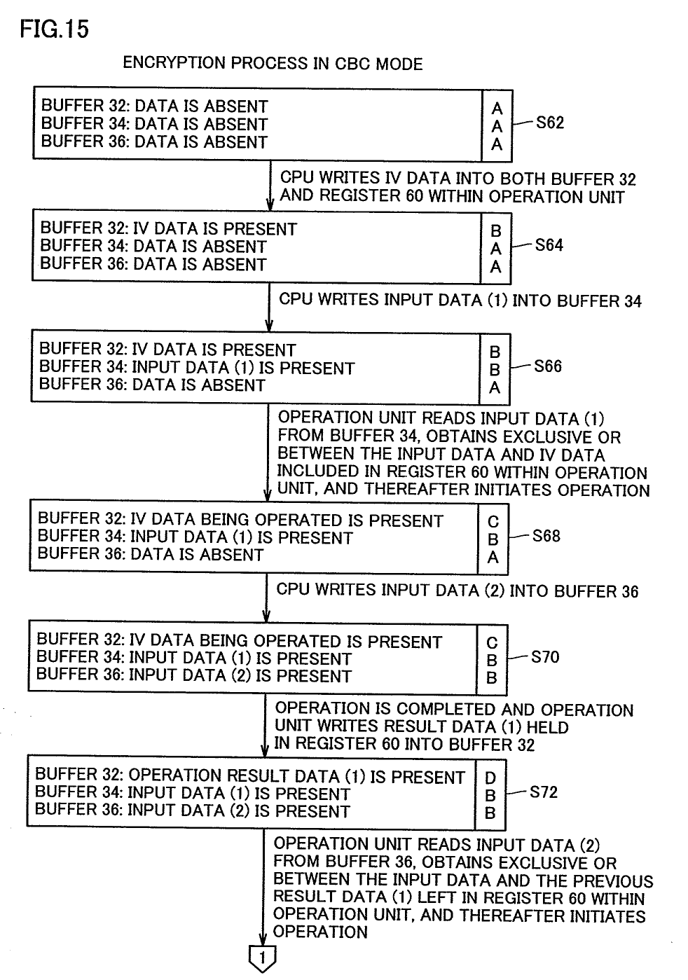

Referring to FIGS. 15 to 17, the encryption process in the CBC mode performed in the data encryption circuit will be described. Though the case where four block data are input in the order of input data (1) to (4) will be described in the description below, it is understood that the number of the input data is not limited to four, and may be a larger or smaller number.

Referring to FIG. 15, in the initial state, buffers 32, 34 and 36 all indicate absence of data (S62). CPU 31 writes IV data into buffer 32 and into register 60 within operation unit 46 (S64). CPU 31 writes input data into buffer 34 (S66). Operation unit 46 reads the input data from buffer 34, and obtains an exclusive OR between the input data and the IV data written into register 60 within operation unit 46, and thereafter initiates operation (S68). CPU 31 writes the input data into buffer 36 (S70). When the operation is completed, operation unit 46 writes the result data into buffer 32 (S72).

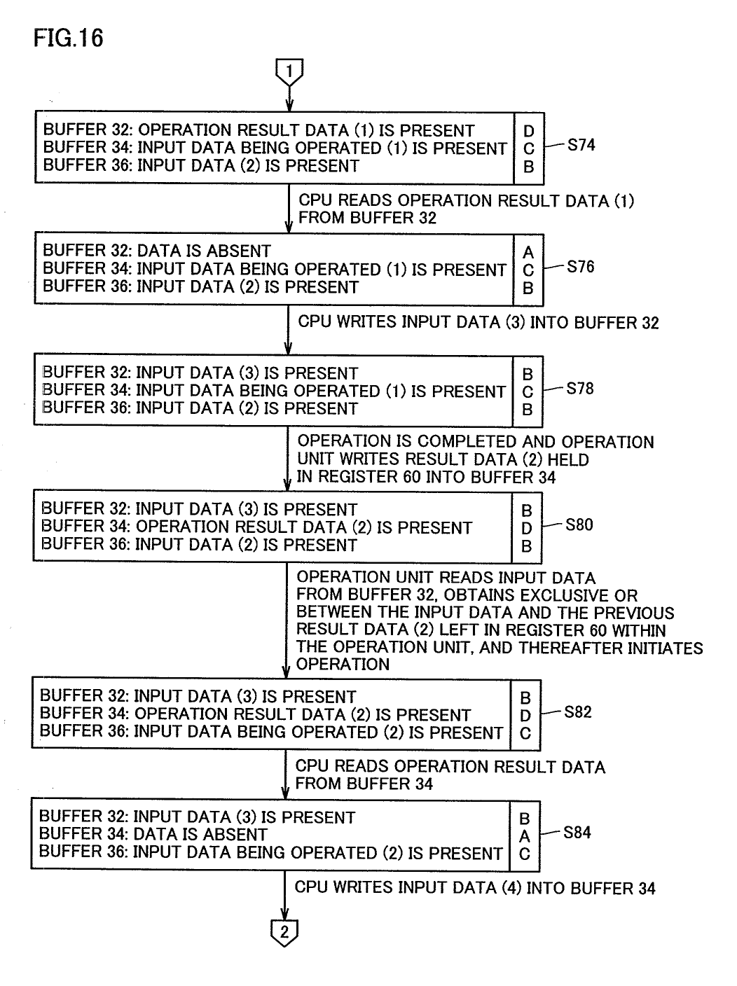

Referring to FIG. 16, operation unit 46 reads the input data from buffer 36, and obtains an exclusive OR between the input data and the previous result data that is left within operation unit 46, and thereafter initiates operation (S74). CPU 31 reads the data of the operation result from buffer 32 (S76). CPU 31 writes the input data into buffer 32 (S78). When the operation is completed, operation unit 46 writes the result data into buffer 34 (S80). Operation unit 46 reads the input data from buffer 32 and obtains an exclusive OR between the input data and the result data of the previous operation that is left within operation unit 46, and thereafter initiates operation (S82). CPU 31 reads the input data from buffer 34 (S84).

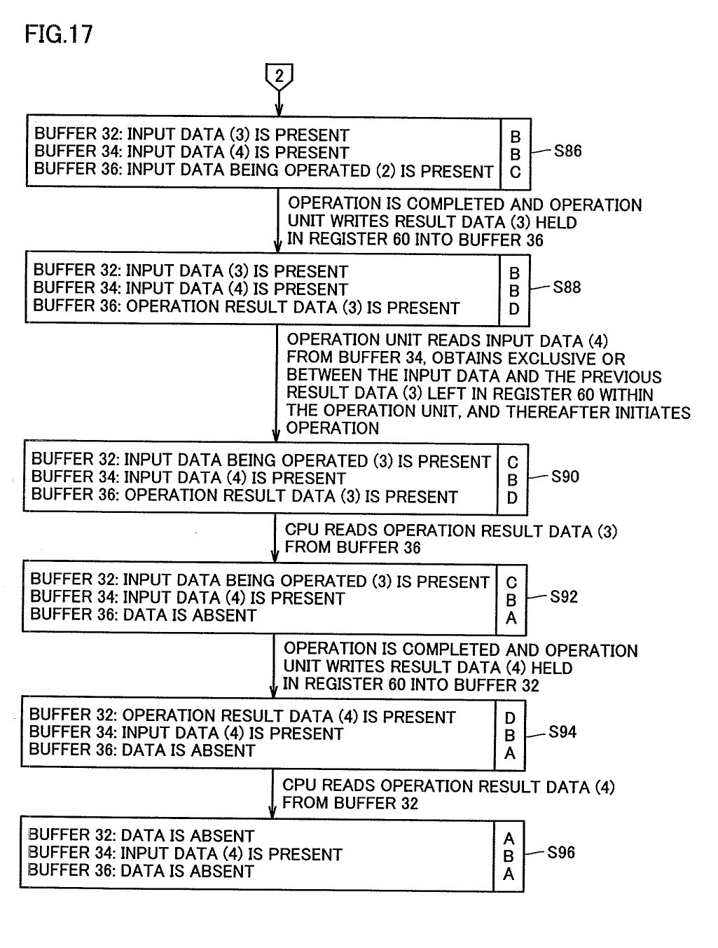

Referring to FIG. 17, CPU 31 writes the input data into buffer 34 (S86). The operation is completed, and then operation unit 46 writes the result data into buffer 36 (S88). Operation unit 46 reads the input data from buffer 34, and obtains an exclusive OR between the input data and the result data of the previous operation that is left within operation unit 46, and thereafter initiates operation (S90). CPU 31 reads the data of the operation result from buffer 34 (S92). When the operation is completed, operation unit 46 writes the result data into buffer 32 (S94). CPU 31 reads the data of the operation result from buffer 32 (S96).

By repeating a series of processes as described above, the encryption process in the CBC mode can be realized.

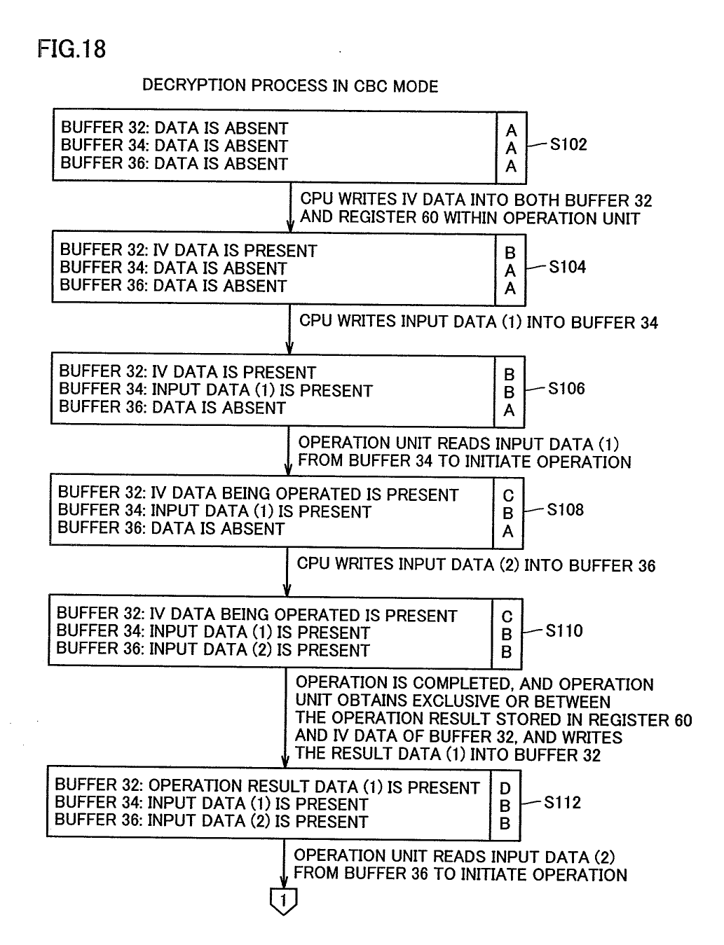

Referring to FIGS. 18 to 20, the decryption process in the CBC mode performed in the data encryption circuit will be described. Though, in the description below, four block data are input in the order of input data (1) to (4), it is noted that the number of the input data is not limited to four, and a larger or smaller number may be employed.

Referring to FIG. 18, in the initial state, buffers 32, 34 and 36 all indicate absence of data (S102). CPU 31 writes IV data into buffer 32 and into register 60 within operation unit 46 (S104). CPU 31 writes the input data into buffer 34 (S106). Operation unit 46 reads the input data from buffer 34, and initiates operation (S108). CPU 31 writes input data into buffer 36 (S110). When the operation is completed, operation unit 46 obtains an exclusive OR between the result data and the IV data held in buffer 32, and writes the result into buffer 32 (S 112).

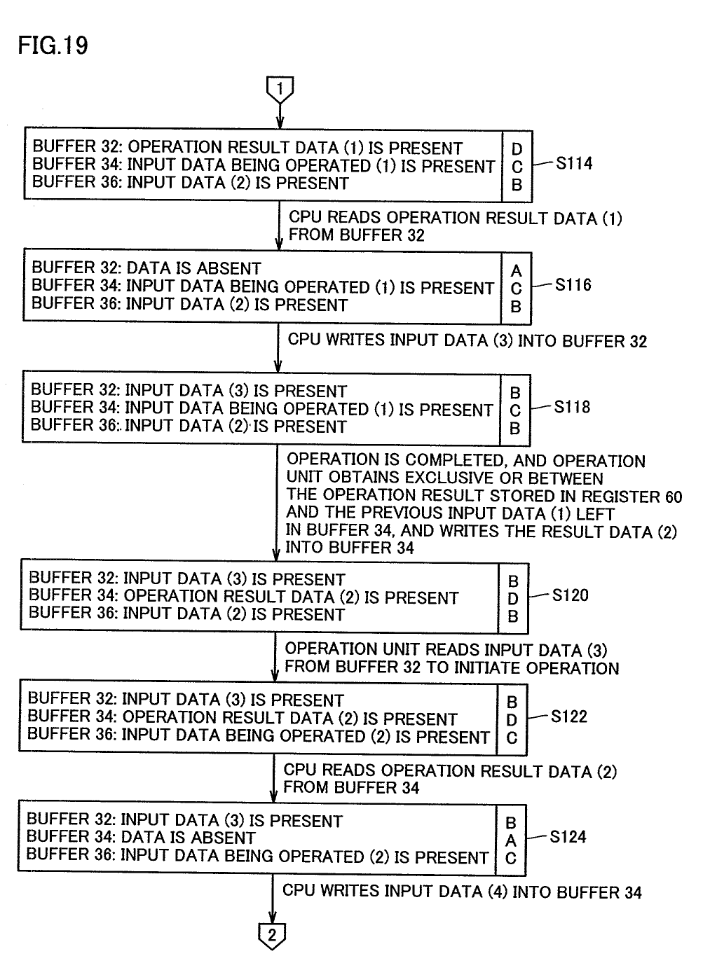

Referring to FIG. 19, operation unit 46 reads the input data from buffer 36, and initiates operation (S114). CPU 31 reads the data of the operation result from buffer 32 (S116). CPU 31 writes input data into buffer 32 (S118). When the operation is completed, operation unit 46 obtains an exclusive OR between the result data and the input data of the previous operation that is held in buffer 34, and writes the result into buffer 34 (S120). Operation unit 46 reads the input data from buffer 32, and initiates the operation (S122). CPU 31 reads the data of the operation result from buffer 34 (S124).

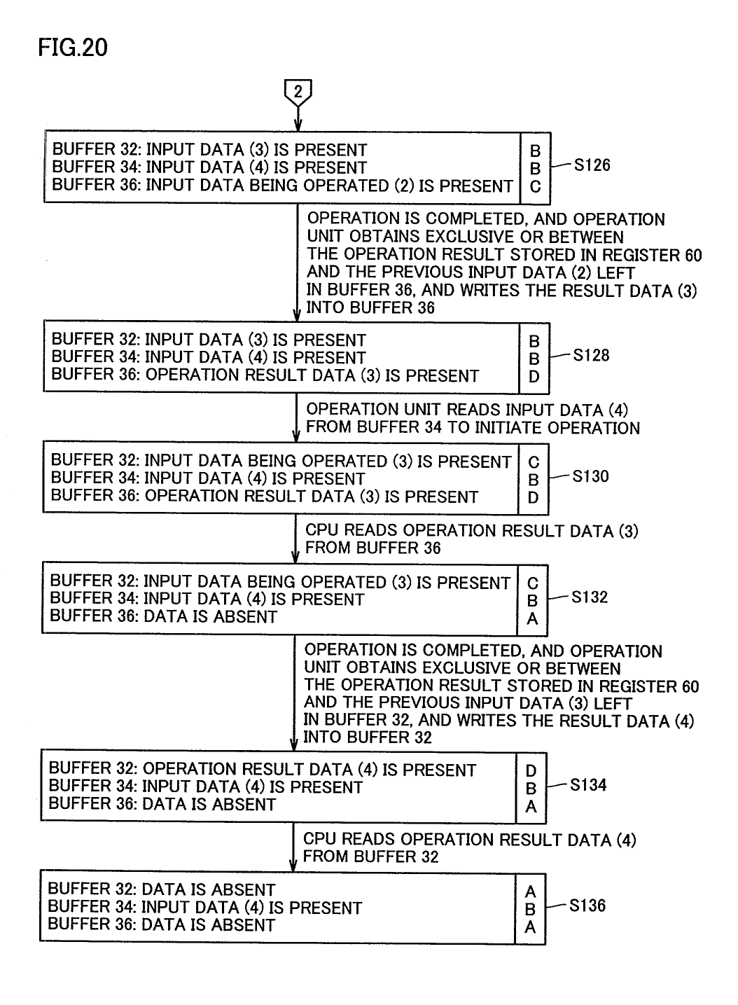

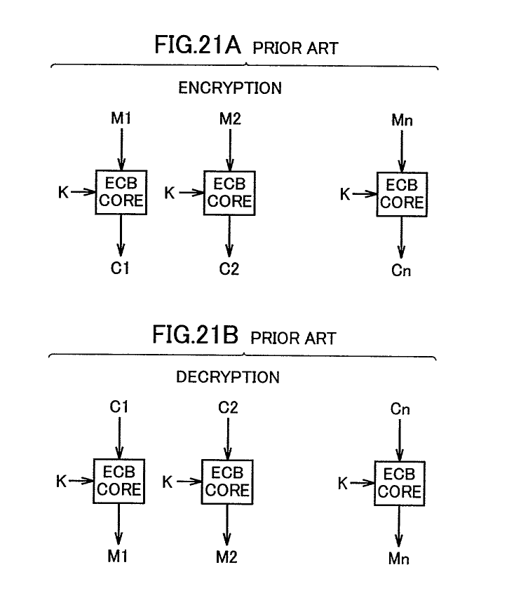

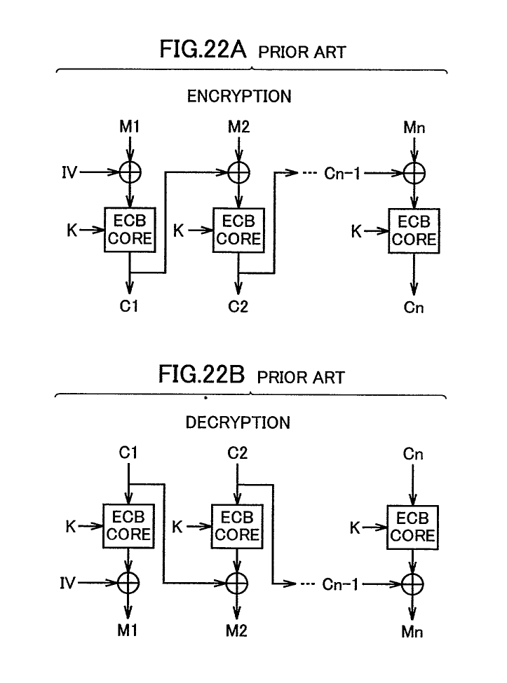

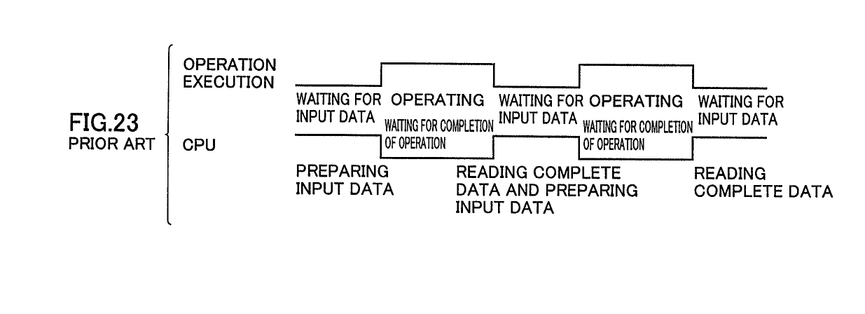

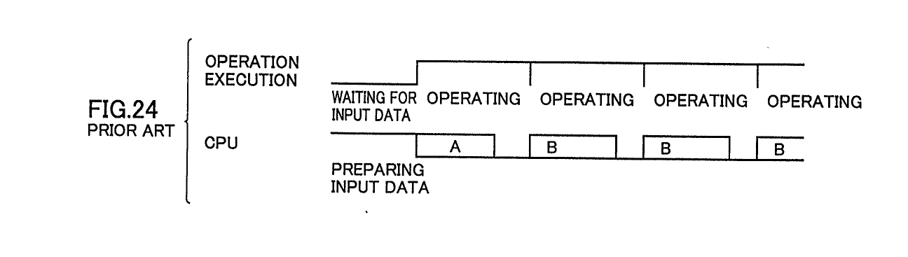

Referring to FIG. 20, CPU 31 writes input data into buffer 34 (S126). When the operation is completed, operation unit 46 obtains an exclusive OR between the result data and the input data of the previous operation that is held in buffer 36, and writes the result into buffer 36 (S 128). Operation unit 46 reads the input data from buffer 34, and initiates operation (S130). CPU 31 reads the data of the operation result from buffer 36 (S 132). When the operation is completed, operation unit 46 obtains an exclusive OR between the result data and the input data of the previous operation that is left in buffer 32, and writes the result into buffer 32 (S134). CPU 31 reads the data of the operation result from buffer 32 (S136).

The reference number of a buffer holding the previous input data is the same as the reference number of the buffer to which the result is written, so that the buffer including the previous input data can be specified using ST_EN32, 34 and 36.

By repeating a sequence of processes as described above, the decryption process in the CBC mode can be realized.

As has been described above, according to the present embodiment, a ring buffer constituted by three buffers is used to serve both as the buffer for input data and as the buffer for output data, as shown in FIG. 7. Therefore, input data to be operated next can be pre-provided even though the operation unit is in the middle of operation, so that the process performance of the data encryption circuit is enhanced. Moreover, the number of buffers is reduced, and thus the data encryption circuit having a small circuit scale and capable of rapid processing can be realized.

It is noted that, the operation unit has constant processing time, whereas the processing time of CPU 31, including reading out and writing to a buffer, is varied generally depending on what is being executed. Hence, the ring buffer may be constituted by buffers in a larger number of stages, to allow rapid execution of the encryption process and decryption process.

Furthermore, in the present embodiment, the encryption process and decryption process in the ECB mode and the encryption process and decryption process in the CBC mode can be realized in one circuit.

In addition, referring to FIG. 2, input data may be input directly into operation processing unit 21 without interposition of register 22. Furthermore, register 22 may temporarily hold intermediate data of operation processing unit 21.

Moreover, referring to FIG. 8, the second input data may be input directly into operation processing unit 62 without interposition of register 60. Furthermore, register 60 may temporarily hold intermediate data of operation processing unit 62.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A data encryption circuit, comprising:
a buffer unit including a plurality of buffers;
an operation unit connected to said buffer unit and capable of transferring data to/reading data from any of the buffers included in said buffer unit, reading block data to be processed from any one of the buffers included in said buffer unit, executing one of an encryption operation process and a decryption operation process, and writing a process result into any one of the buffers;
a data control unit connected to said buffer unit, writing block data to be processed into any one of the buffers included in said buffer unit, and reading an operation result at said operation unit from any one of the buffers; and
a buffer designating unit connected to said buffer unit, said operation unit and said data control unit, designating buffers to be an object of input/output with respect to said operation unit and said data control unit, so as to prevent coincidence of a buffer into which data is read by said operation unit, a buffer into which data is written by said operation unit, a buffer into which data is read by said data control unit, and a buffer into which data is written by said data control unit.

2. The data encryption circuit according to claim 1, wherein said buffer designating unit includes
a plurality of state registers respectively holding states taken by the plurality of buffers included in said buffer unit, and
a decoder connected to said plurality of state registers, and supplying signals corresponding to values of said plurality of state registers to the plurality of buffers constituting said buffer unit, to said operation unit and to said data control unit; and
said operation unit and said data control unit operate based on the signals supplied from said decoder.

3. The data encryption circuit according to claim 2, wherein each of said plurality of state registers stores, in a corresponding buffer, data indicating any one of a state where pre-operation data can be written, a state where pre-operation data is stored, a state where an operation result is stored, and a state where stored data is being operated.

4. The data encryption circuit according to claim 3, wherein said decoder supplies, to each of said plurality of buffers, a first signal indicating whether said data control unit can write block data, a second signal indicating whether said data control unit can read an operation result, a third signal indicating whether said operation unit can take out input data waiting for operation, and a fourth signal indicating whether said operation unit can write an operation result.

5. The data encryption circuit according to claim 4, wherein said decoder supplies said third and fourth signals such that an operation result is written into a same buffer as a buffer from which block data is taken out by said operation unit.

6. The data encryption circuit according to claim 3, wherein said buffer unit is constituted by three or a larger number of buffers.

7. The data encryption circuit according to claim 2, wherein said decoder supplies, to each of said plurality of buffers, a first signal indicating whether said data control unit can write block data, a second signal indicating whether said data control unit can read an operation result, a third signal indicating whether said operation unit can take out input data waiting for operation, and a fourth signal indicating whether said operation unit can write an operation result.

8. The data encryption circuit according to claim 7, wherein said decoder supplies said third and fourth signals such that an operation result is written into a same buffer as the buffer from which block data is taken out by said operation unit.

9. The data encryption circuit according to claim 8, wherein said buffer unit is constituted by three or a larger number of buffers.

10. The data encryption circuit according to claim 7, wherein said buffer unit is constituted by three or a larger number of buffers.

11. The data encryption circuit according to claim 2, wherein said buffer unit is constituted by three or a larger number of buffers.

12. The data encryption circuit according to claim 2, wherein said buffer designating unit allows said buffer unit to function as a ring buffer.

13. The data encryption circuit according to claim 1, wherein said buffer designating unit designates a buffer to which data is written by said operation unit and a buffer to which data is read by said data control unit, so as to prevent coincidence of the buffer to which data is written by said operation unit and the buffer to which data is read by said data control unit from each other.

14. The data encryption circuit according to claim 13, wherein said buffer unit is constituted by three or a larger number of buffers.

15. The data encryption circuit according to claim 1, wherein said buffer unit is constituted by three or a larger number of buffers.

16. The data encryption circuit according to claim 15, wherein said operation unit includes
a register holding data,
an operation processing unit connected to said register, providing one of encryption operation and decryption operation to the data held in said register, and writing an operation result into said register,
a first selecting circuit connected to said register, outputting a value held in said register when said mode is a Cipher Block Chaining mode and a process currently being executed is an encryption process, and outputting zero in other cases,
a first exclusive OR circuit connected to said first selecting circuit, said buffer unit and said register, obtaining an exclusive OR between an output of said first selecting circuit and a value held in any one of the buffers constituting said buffer unit, and using the exclusive OR as an input to be operated for encryption,
a second selecting circuit connected to said buffer unit, outputting a value held in any one of the buffers constituting said buffer unit when an encryption mode is the Cipher Block Chaining mode and a process currently being executed is a decryption process, and outputting zero in other cases, and
a second exclusive OR circuit connected to said second selecting circuit, said buffer unit and said register, obtaining an exclusive OR between an output of said second selecting circuit and a value held in said register, and writing the exclusive OR into any one of the buffers constituting said buffer unit.

17. The data encryption circuit according to claim 1, wherein said buffer designating unit allows said buffer unit to function as a ring buffer.
